(19) United States
(12) Patent Application Publication
(10) Pub. No.: US 2014/0165037 A1
(43) Pub. Date: Jun. 12, 2014

(54) REUSABLE APPLICATION USER EXPERIENCE

(71) Applicant: MICROSOFT CORPORATION, Redmond, WA (US)

(72) Inventors: Eric Brun, Sammamish, WA (US); Henricus Johannes Maria Meijer, Mercer Island, WA (US); Arnaud C. Flutre, Sammamish, WA (US); Boris Vidolov, Redmond, WA (US); Brian Beckman, Newcastle, WA (US); Eyal Ofek, Redmond, WA (US)

(73) Assignee: MICROSOFT CORPORATION, Redmond, WA (US)

(21) Appl. No.: 13/712,206

(22) Filed: Dec. 12, 2012

(51) Int. Cl. G06F 9/44

(52) U.S. Cl. CPC G06F 8/71
USPC 717/122

(57) ABSTRACT

Reusable user experience is provided by way of styleable applications. An application can be segmented into a content portion and a style portion, if not originally designed that way. Subsequently, alternate style code can be injected to provide a style to an application lacking style or replace a style with a different style. Styles can be extracted from other applications or acquired from an online marketplace, for instance.

### BACKGROUND

User experience with a software application is dictated primarily by the application's user interface. Generally, a user interface defines how users interact with applications running on a computer. More specifically, a user interface refers to graphical, textual, and auditory information presented to a user as well as the manner in which input is accepted from the user to control the application such as by way of keystroke sequences or movements/selections with a mouse or touchscreen. A user interface can be styled in many ways utilizing various combinations and layouts of text, graphics, and sounds, for example. Much thought and time are expended by software developers to determine a software application's style, or presentation semantics, to provide a positive user experience. Once determined, the style is fixed and not subject to end-user modification. In some instances, however, an application is designed to support different themes, or skins, that allow limited alteration of presentation. For example, an application can allow themes that alter an application's background color or image.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to reusable user experience. Software application styles can be modified to provide a desired user experience. Moreover, styles can be reused across software applications and execution environments. A styleable application can be produced by segmenting style from other applications parts and optionally removing style. A stylized application can be generated from a styleable application as a function of a style definition selected by an end-user. Style definitions can be extracted from existing software applications. Additionally or alternatively, style definitions can be acquired from an online style marketplace configured to acquire styles definitions from producers and distribute style definitions to consumers.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an application stylization system.

FIG. 2 is a block diagram depicting stylization of an application.

FIG. 3 is a block diagram of a style acquisition system.

FIG. 4 is a block diagram of an online marketplace system.

FIG. 5 is a flow chart diagram of a method of styling an application.

FIG. 6 is a flow chart diagram of a method of application styling.

FIG. 7 is a flow chart diagram of a method of capturing style.

FIG. 8 is a flow chart diagram of provisioning application style.

FIG. 9 is a schematic block diagram illustrating a suitable operating environment for aspects of the subject disclosure.

### DETAILED DESCRIPTION

Details below are generally directed toward a reusable user experience. The style of a software application or, in other words, an application's presentation semantics (e.g., layout, colors, fonts . . . ), can be modified to provide a desired user experience. Moreover, style can propagate across applications, or application execution environments or vendor ecosystems. A styleable application can be generated by segmenting style from other parts of the application and optionally removing a current style. Subsequently, a new style can be added that replaces a current style or provides a style to an application devoid of style. Style can be acquired from another software application, or an online style marketplace or the like.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

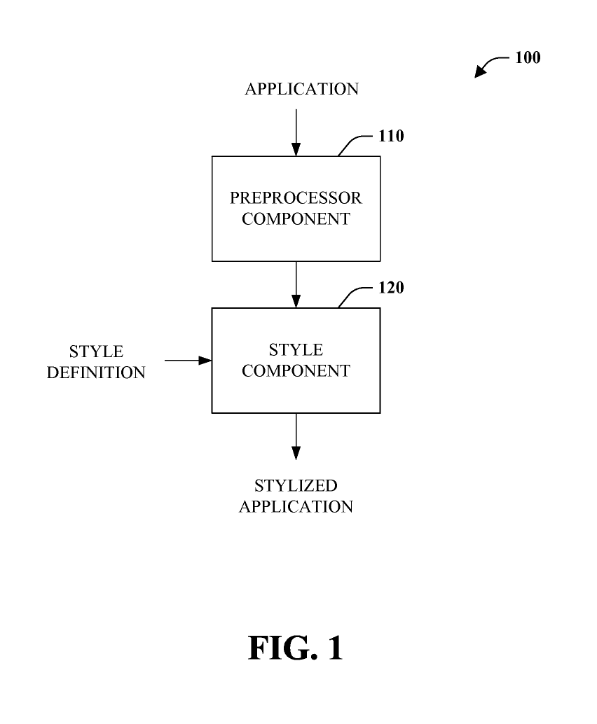

Referring initially to FIG. 1, an application stylization system 100 is illustrated. The system 100 includes preprocessor component 110 communicatively coupled with style component 120. A software application may not be initially designed to enable styling as described herein. The preprocessor component 110 transforms the application, or produces a new version of the application, able to be processed by the style component 120. The style component 120 can generate a version of the original input application, namely a stylized application (e.g., skinned application), which includes a style defined by a style definition. Accordingly, a software application's style and thus a user's experience can be modified to correspond to any style definition.

The preprocessor component 110 receives, retrieves, or otherwise obtains or acquires a software application including a combination of parts pertaining to content and style, for instance. Content refers to the essence of the software application including what and how something is computed. Style refers to a form or presentation comprising one or more design elements such as, but not limited to, color, font, sound, images, and layout. The preprocessor component 110 is configured to identify the style of an input application. For example, the preprocessor component 110 can identify style based on metadata indicative of style and/or by excluding content based on characteristics thereof. Once style is identified a new application, or, in other words, a new version of the acquired application is generated. The new version of the application can segment the application style from other parts of the application such as content thus producing a styleable application. Optionally, the preprocessor component 110 can be configured to remove the style from the application, thereby producing an application devoid of style or, in other words, a styleless application.

The style component 120 operates over a styleable or styleless version of the application produced by the preprocessor component 110. Further, the style component 120 is configured to receive, retrieve, or otherwise obtain or acquire a style definition and generate a stylized application. The stylized application is a new application or new version of the application that is styled in accordance with the style definition. In other words, the stylized application is encoded with the style provided by the style definition. Further, the style definition need not be static but rather can change dynamically as changes are made to a style. Accordingly, the style component 120 can produce an application is linked to a dynamic style definition.

In accordance with one embodiment, application styling can pertain to setting a background, color, and/or font. However, styling can also be more sophisticated. For instance, a style can identify a particular layout such as three buttons in the middle of a screen. In this case, styling will involve mapping presentation content and functionality to those three buttons. As another non-limiting example, if an application includes bluish images and a new style is red, the images can be modified to be reddish to fit the new style. Accordingly, the style component 120 can include or invoke external functionality to enable arbitrarily sophisticated styling. Furthermore, style can be a set of relations between parameters and not just their values. For example, once a color is set there may be a need to set another color with the same hue but brighter or there can be some contrast between colors. The same is valid for font sizes and spaces, among other things. Still further yet, it is to be appreciated that style can include three-dimensional arrangement, for example for stereo displays and alternate realty/virtual reality. In instance, content can be organized in space around a user in a way such that significant words are aligned in different distances from the user such that content appears to be bulging out.

Additionally, the system 100 thus provides mechanisms to enable application end-users to style or restyling applications without developer intervention. Accordingly, there is no need for coding or employment of reverse engineering tools. Stated differently, the system 100 enables application style refactoring for end-users.

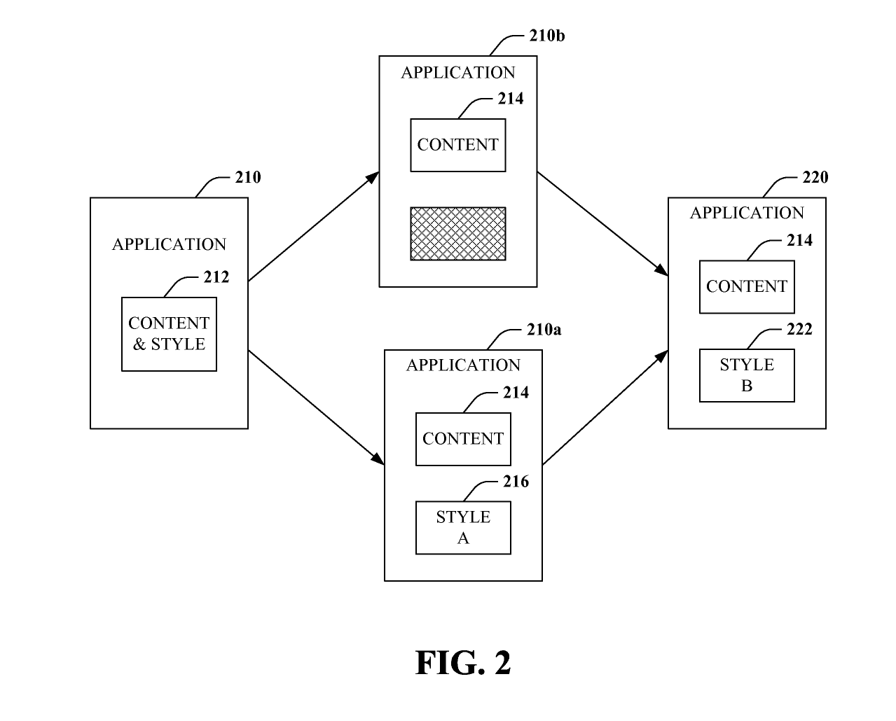

FIG. 2 is a block diagram illustration of software application stylization. A software application 210 comprising a combination of content and style 212 can be provided as input to the preprocessor component 110 (FIG. 1). In one embodiment, the output of the preprocessing can be a version of the application 210a, wherein the style, here style “A” 216, can be segmented from the content 214. In another embodiment, a new version of the application 210b can be generated that strips style from the application leaving content 214. The style component 120 (FIG. 1) can subsequently generate another version of the application 220 with a new style, here style “B” 222. In the first embodiment, style “A” 216 can be overwritten or swapped with style “B” 222. In the second embodiment, style “B” 222 can simply be added to the styleless version.

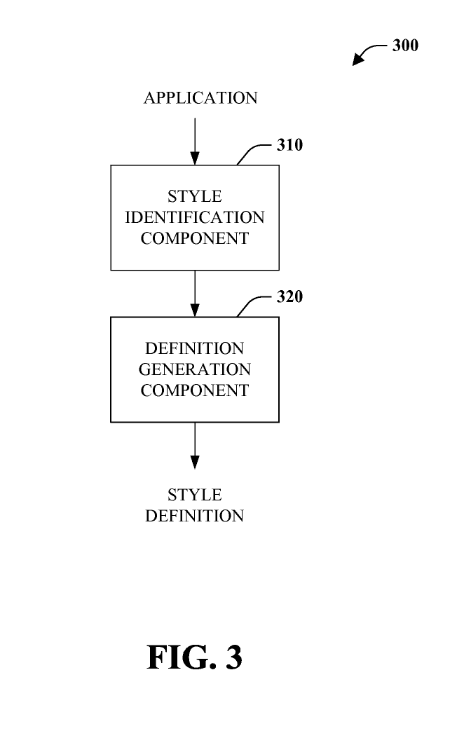

FIG. 3 depicts a system 300 that facilitates style acquisition. The system 300 include style identification component 310 communicatively coupled with definition generation component 320. The style identification component 310 is configured to analyze an application and identify a style associated with the application. Such functionality can be enabled by analyzing code and/or a visual representation. For example, the style identification component 310 can determine that an aspect of the application's style includes a set number of buttons. Additionally, the identification can identify a particular color and font employed by the application. Once a style comprising a plurality of style elements or parameters is identified, the definition generation component 320 can be initiated. The definition generation component 320 is configured to generate a style definition based on an identified style. The style definition can subsequently be employed to allow other applications to adopt the same style thereby allowing reuse of styles and user experience. Further, style acquisition need not end with a batch process that scans software, but can be configured to continue on-line as particular style is modified (e.g., developer adds or edits code).

According to one aspect of the subject invention, functionality provided by system 100 and system 300 can be initiated and employed utilizing user-interface interaction techniques, such as drag and drop and copy and paste. By way of example, upon identifying a desired style of another's application, the style can be copied and subsequently pasted into a user's application causing the user's application to be similarly styled. Similarly, a user can drag and drop a style from one application to another. Such a process can involve identifying a style and generating a style definition as described with respect to FIG. 3 and subsequently generating a stylized application based on the style definition by preprocessing an input application and subsequently styling an application as described with respect to FIG. 1. The process can be simplified if developers design software applications to include a style that can be copied and/or modified. For instance, application developer can expose a style definition for acquisition and/or provide hooks to accept a style definition.

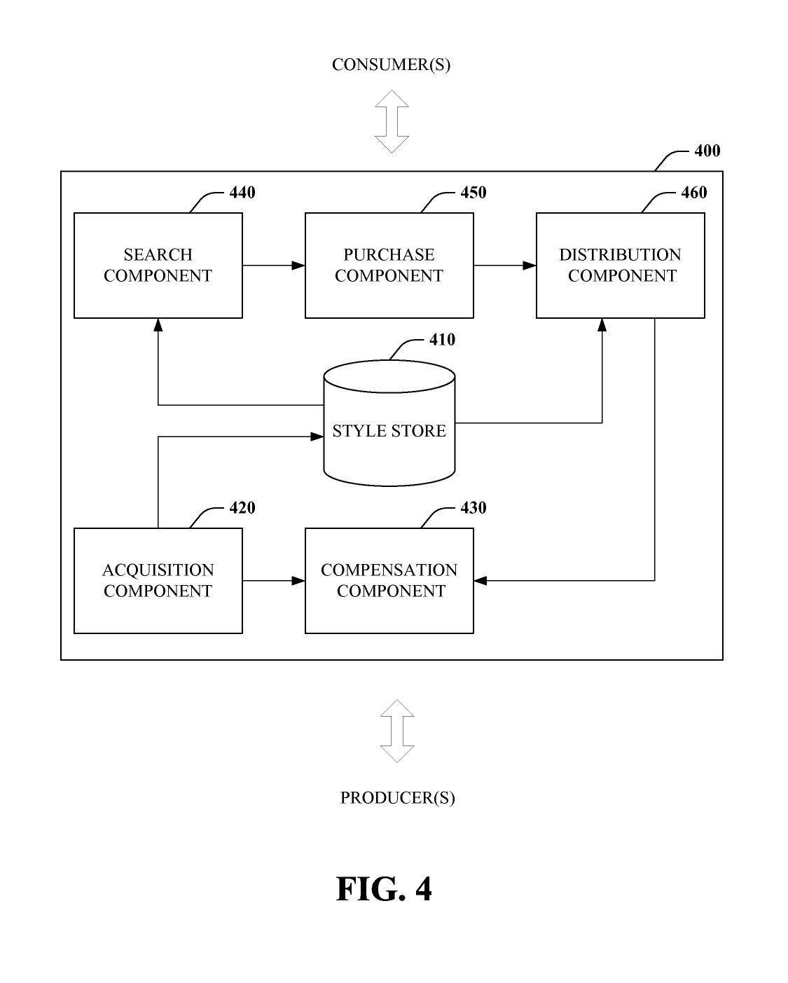

FIG. 4 illustrates an online marketplace system 400 for application styles. In other words, the system 400 can be embodied as a web service accessible over a network, such as the Internet, to publish and acquire styles. The system includes style store 410 that provides persistent and non-volatile storage of styles, or more specifically style definitions. Acquisition component 420 is configured to enable the system 400 to acquire styles from style producers. For instance, the acquisition component 420 can provide an interface that allows submission of style definitions by a developer. The compensation component 430 initiate provisioning of compensation including, but not limited to, monetary compensation to a producer who submits a style definition to the system. Such compensation can be designed to incentivize producers of styles to provide styles to the system.

System 400 also includes search component 440. Search component 440 is configured to enable a potential consumer of a style to locate a style of interest. For example, the search component 440 can acquire and service queries for particular style elements (e.g., layout, color . . . ). In accordance with one aspect, style definitions housed in the style store 410 can include a pre-computed value indicative of a distance between different styles as a way to capture the likeness of styles. Consequently, the search component 440 in addition to providing styles that satisfy a query can also recommend like styles as captured by the distance between styles. A consumer can identify a desired style by way of a selection signal (e.g., single click, double click, highlight, touch . . . )

Upon identifying a desired style via the search component 440, for instance, a consumer can purchase the style. The purchase component 450 can at least initiate a purchase transaction, for example by way of an external service, to allow the style to be purchased. After purchasing a style, the distribution component 460 is configured to acquire the style definition from the style store 410 and at least initiate transmission or distribution of the style definition to the purchasing consumer. Of course, a style definition could be free, in which case the purchase component 450 can be bypassed.

In accordance with one aspect, a style producer can be compensated as a function of the number of distributed style definitions. Hence, the distribution component 460 can notify the compensation component 430 upon distribution of a style. The compensation component 430 can keep track of the total number of distributed styles and at least initiate compensation of a producer periodically as a function thereof. For example, a developer could be compensated one dollar for each distribution of a style. In this manner, a developer is incentivized to design a popular style since compensation is dependent on the number of purchases and/or distributions of the style.

In accordance with one aspect of the subject invention, inter-application styling is enabled. Conventionally, intra-application styling has been enabled in which an application enables a few application specific themes to be employed. Here, however, software application styling can be performed across different applications. For instance, application “A” can be stylized to employ the style of application “B, where application “A” is a game and application “B” is a photograph viewer. Further, styling can be performed across different execution environments or vendor ecosystems for the same or similar application. For example, if the style of application “A” is different an execution environment “X” than it is for execution environment “Y,” the style associated with the application in execution environment “X” can be utilized to stylize application associated with execution “Y” or vice versa. As a more concrete, but not limiting, example, a Windows Phone® application can be stylized with the style of the same iPhone® application or an iPhone® application can be stylized with the style of a Windows Phone® application.

According to another aspect of the invention, limitations can be communicated and respected with respect to the acquisition or copying of a style. Absent any limitations or restrictions, substantially any application style can be captured and utilized to style another application. In an instance in which an application developer does not want to allow a style to be copied, such a desire can be signaled in a variety of manners. For example, metadata can be included indicating that a style should not be copied. Further, a hidden signature such as a watermark can be included within stylistic aspects to facilitate identification of a style that may be been acquired without authorization. Additionally, an application can indicate that some style elements authorized to be copied while other elements are not.

Similarly, limitations, restrictions, or the like can specified with respect to styling or style application. In some instance, it may not be desirable to style or restyle portions of an application but rather preserve styling, for instance with respect to advertising, reporting, or marketing material. Consider a company logo or design, for example. A company can invest a lot of time and money into a brand and characteristics of a brand such as a particular color. Accordingly, it is unlikely that a company logo should be restyled. In known situations such as company logos, the new style can simply not be applied logos. For example, one or more style elements can be indicated as not subject to styling, or, in other words, current styling is to be preserved. Additionally or alternative, permission can be requested from an application user and/or rights holder (e.g., trademark owner) prior to styling particular elements.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the style identification component can employ such mechanisms to enable a style to determined or inferred from code and/or visual presentation.

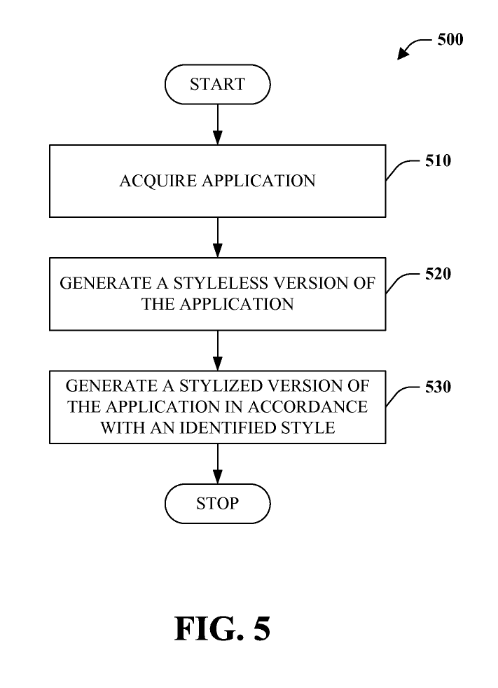

In view of the exemplary systems described supra, methodologies that may be implemented in accordance with the disclosed subject matter will be better appreciated with reference to the flow charts of FIGS. 5-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 5, a method 500 of application styling is illustrated. At reference numeral 510, a software application is received, retrieved, or otherwise obtained or acquired. At numeral 520, a styleless version of the application is generated. In other words, a version of the application is generated that is devoid of style (e.g., de-skinned). In one embodiment, this can be accomplished by identifying and segmenting style from other parts of the applications comprising content and removing the style. At reference numeral 530, a stylized version of the application is generated in accordance with an identified style (e.g. skinned). More specifically, an identified style definition can be applied to or encoded in the application version to produce a version of that application with the defined style.

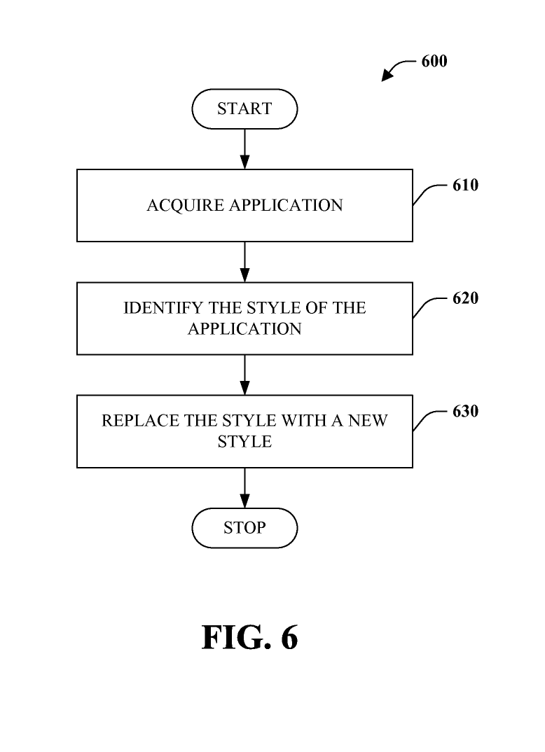

FIG. 6 depicts a method 600 of styling a software application. A software application is received, retrieved, or otherwise obtained or acquired at reference numeral 610. At numeral 620, the style of the application is identified. Although not limited thereto, in one embodiment, the acquired application can be a styleable application with style segmented rather than intertwined with application content. Further, it is also possible that the style identified is actually no style at all, meaning the application is devoid of style (e.g., de-skinned). At reference numeral 630, the identified style is replaced with a new style, for example provided by a style definition, to produce a newly styled or in other words re-styled application (e.g., skinned).

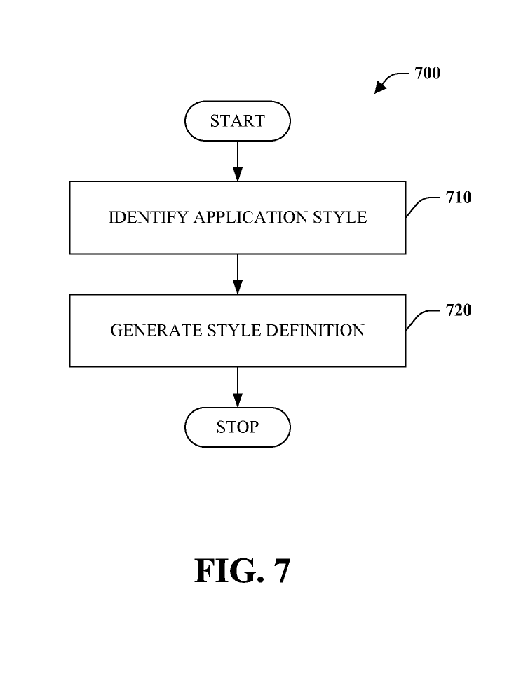

FIG. 7 is a flow chart diagram of a method 700 of capturing an application style. At numeral 710, an application style can be identified. Style identification can accomplished in a myriad of ways including analyzing code and/or presentation text, images, audio and layout, among other things. At reference numeral 720, a style definition is generated as a function of an identified style. In other words, the style is encoded or specified in a programming language. In accordance with one aspect, one or more actions of method 700 can be constrained or restricted if an application signals, for instance by way of metadata, that capture of some or all of the application's style is unauthorized.

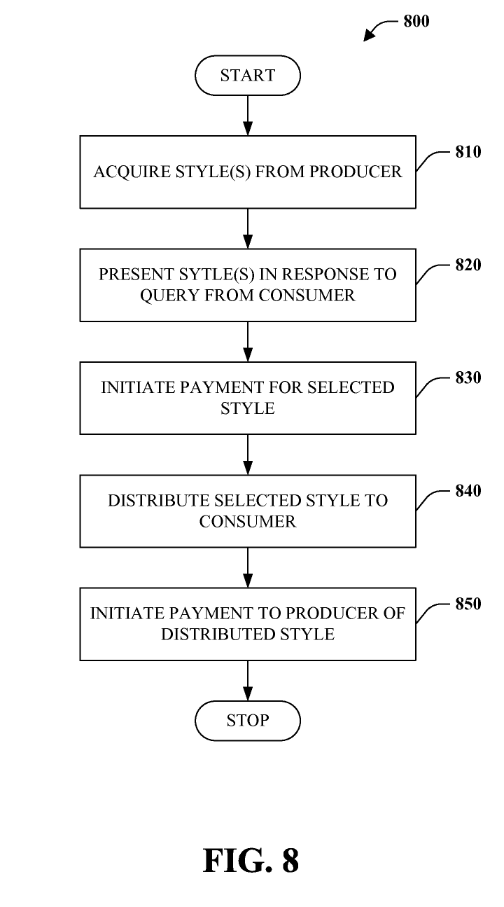

FIG. 8 illustrates a method 700 of provisioning application styles, for instance by way of an online marketplace. At reference numeral 810, one or more styles are acquired from a producer, which can be a single developer or a software vendor, for example. Styles can be supplied by the producer in a particular format such as a standardized style definition. At numeral 820, one or more styles supplied by produces can be presented to a potential consumer in response to a query. For example, an application user can submit a query to a search engine for a style definition to use to stylize his/her application. In addition to styles response to the query, recommended styles can also be provides as a function of a value indicative of the distance of styles from a queries style. From the set of supplied styles, a style can be selected by way of a selection signal (e.g., single click, double click, highlight, touch . . . ). At reference 830, payment can be at least initiated for a selected style. At numeral 830, distribution is of the selected style is at least initiated upon confirmation of payment, if applicable. At reference numeral 850, payment is initiated to a producer of the distributed style as compensation providing the style.

Furthermore, it is to be appreciated that a mechanism provided to facilitate comparison of styles. For example, two different styles can be applied to content and the mechanism can identify differences between the styles (e.g., without the differences that originated from the style change).

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the terms “component,” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “′X′ or ‘Y’” is intended to mean any inclusive permutations of “X” and “Y.” For example, if “′A′ employs ‘X,’” “′A employs ‘Y,’” or “′A′ employs both ‘X’ and ‘Y,’” then “′A′ employs ‘X’ or ‘Y’” is satisfied under any of the foregoing instances.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

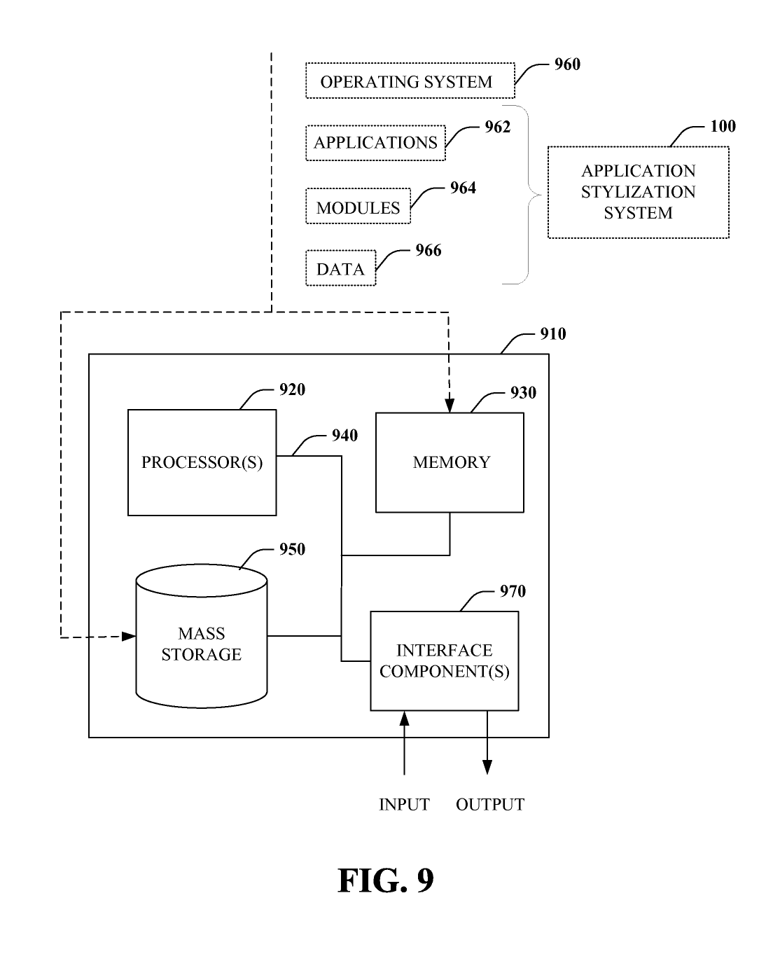

In order to provide a context for the claimed subject matter, FIG. 9 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 9, illustrated is an example general-purpose computer 910 or computing device (e.g., desktop, laptop, tablet, server, hand-held, programmable consumer or industrial electronics, set-top box, game system, compute node . . . ). The computer 910 includes one or more processor(s) 920, memory 930, system bus 940, mass storage 950, and one or more interface components 970. The system bus 940 communicatively couples at least the above system components. However, it is to be appreciated that in its simplest form the computer 910 can include one or more processors 920 coupled to memory 930 that execute various computer executable actions, instructions, and or components stored in memory 930.

The processor(s) 920 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 920 may also be implemented as a combination of computing devices, for example a combination of a DSP and a microprocessor, a plurality of microprocessors, multi-core processors, one or more microprocessors in conjunction with a DSP core, or any other such configuration.

The computer 910 can include or otherwise interact with a variety of computer-readable media to facilitate control of the computer 910 to implement one or more aspects of the claimed subject matter. The computer-readable media can be any available media that can be accessed by the computer 910 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums which can be used to store the desired information and which can be accessed by the computer 910. Furthermore, computer storage media excludes modulated data signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 930 and mass storage 950 are examples of computer-readable storage media. Depending on the exact configuration and type of computing device, memory 930 may be volatile (e.g., RAM), non-volatile (e.g., ROM, flash memory . . . ) or some combination of the two. By way of example, the basic input/output system (BIOS), including basic routines to transfer information between elements within the computer 910, such as during start-up, can be stored in nonvolatile memory, while volatile memory can act as external cache memory to facilitate processing by the processor(s) 920, among other things.

Mass storage 950 includes removable/non-removable, volatile/non-volatile computer storage media for storage of large amounts of data relative to the memory 930. For example, mass storage 950 includes, but is not limited to, one or more devices such as a magnetic or optical disk drive, floppy disk drive, flash memory, solid-state drive, or memory stick.

Memory 930 and mass storage 950 can include, or have stored therein, operating system 960, one or more applications 962, one or more program modules 964, and data 966. The operating system 960 acts to control and allocate resources of the computer 910. Applications 962 include one or both of system and application software and can exploit management of resources by the operating system 960 through program modules 964 and data 966 stored in memory 930 and/or mass storage 950 to perform one or more actions. Accordingly, applications 962 can turn a general-purpose computer 910 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the application stylization system 100, or portions thereof, can be, or form part, of an application 962, and include one or more modules 964 and data 966 stored in memory and/or mass storage 950 whose functionality can be realized when executed by one or more processor(s) 920.

In accordance with one particular embodiment, the processor(s) 920 can correspond to a system on a chip (SOC) or like architecture including, or in other words integrating, both hardware and software on a single integrated circuit substrate. Here, the processor(s) 920 can include one or more processors as well as memory at least similar to processor(s) 920 and memory 930, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the application stylization system 100 and/or associated functionality can be embedded within hardware in a SOC architecture.

The computer 910 also includes one or more interface components 970 that are communicatively coupled to the system bus 940 and facilitate interaction with the computer 910. By way of example, the interface component 970 can be a port (e.g., serial, parallel, PCMCIA, USB, FireWire . . . ) or an interface card (e.g., sound, video . . . ) or the like. In one example implementation, the interface component 970 can be embodied as a user input/output interface to enable a user to enter commands and information into the computer 910, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 970 can be embodied as an output peripheral interface to supply output to displays (e.g., CRT, LCD, plasma . . . ), speakers, printers, and/or other computers, among other things. Still further yet, the interface component 970 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A computer-implemented method, comprising:
producing a styleable version of a software application; and
generating a stylized version of the software application as a function of the styleable version of the software application and a style definition.

2. The method of claim 1, producing the styleable version of the software application comprises segmenting style from content of the software application.

3. The method of claim 2 further comprises replacing code specifying the style with code corresponding to the style definition.

4. The method of claim 2 further comprises removing the style from the software application.

5. The method of claim 4 further comprises encoding style corresponding to the style definition.

6. The method of claim 1 further comprises initiating the producing and generating in response to a user-interface action with respect to the software application.

7. The method of claim 1, generating the stylized version after selection of the style definition from an online style marketplace.

8. The method of claim 1, generating the stylized version after selection of the style definition with respect to a different software application.

9. The method of claim 1, generating the stylized version after selection of the style definition with respect to a version of the software application executable in a different execution environment.

10. A system, comprising:
a processor coupled to a memory, the processor configured to execute the following computer-executable components stored in the memory:
a first component configured to locate a style definition in response to a user query; and
a second component configured to provide the style definition to the user in response to a selection signal.

11. The system of claim 10, the first component is configured to locate one or more other style definitions similar to the style definition based on a pre-computed value indicative of distance between styles.

12. The system of claim 10 further comprises a third component that initiates a payment process in response to the selection signal.

13. The system of claim 10 further comprises a third component configured to compensate a producer of the style definition as a function of a number of purchases of the style definition.

14. The system of claim 10 further comprises a third component configured to acquire one or more style definitions from a producer.

15. The system of claim 14 further comprises a fourth component configured to compensate the producer for the one or more style definitions.

16. A computer-readable storage medium having instructions stored thereon that enable at least one processor to perform a method upon execution of the instructions, the method comprising:
generating a stylized version of a first software application by adding code specifying a style designed for a second software application.

17. The method of claim 16 further comprises generating a styleless version of the first software application prior to generating the stylized version.

18. The method of claim 16 further comprises initiating the generating of the stylized version in response to a selection signal with respect to the second software application.

19. The method of claim 16 further comprising checking whether the style designed for the second software application is authorized for use prior to generating the stylized version.

20. The method of claim 16 further comprising identifying a portion of the first application for which the style is inapplicable.
